(19) United States
(12) Patent Application Publication
(10) Pub. No.: US 2009/0031264 A1
(43) Pub. Date: Jan. 29, 2009

(54) System and method for finding electromigration, self heat and voltage drop violations of an integrated circuit when its design and electrical characterization are incomplete

(76) Inventors: Dan Rittman, Atlit (IL); Irina Geselev, Portland, OR (US)

Correspondence Address: DANNY RITTMAN, P.O. BOX 2040, Atlit, 30300, IL

(21) Appl. No.: 11/880,611

(22) Filed: Jul. 24, 2007

(51) Int. Cl. G06F 17/50

(52) U.S. Cl. 716/5

(57) ABSTRACT

A system and method for finding electromigration (EM), self heat (SH) and voltage drop/droop violations of an integrated circuit, when its design and electrical characterization are not complete, are disclosed. The method includes analyzing polygons for average, root-mean-square (RMS) and Ipeak current densities and voltages of a mask layout block and obtaining one or more electromigration, self heat and/or voltage drop/droop rules associated with the polygon from a technology and an external constraints file. The system reads the available design simulation data to calculate the average, RMS and Ipeak current densities and voltages, and estimates the current densities and voltages when no data available. The method also includes topological analysis of the mask layout and analysis of the electrical circuit elements of the design. The method finds the polygons where the current densities are higher than electromigration and self heat rules as taken from technology or external constraints file. The method also finds the polygons where the current densities are higher than in other polygons, by the defined threshold. The method also finds the nodes where the voltage drop/droop is larger than the rule. The method also finds the polygons where the voltage drop/droop is larger than in other polygons by the defined threshold. The method and system work on GDSII, GDSIII format files and on industry standards layout editors' database.

### TECHNICAL FIELD OF THE INVENTION

The present invention is generally related to the field of integrated circuits, and more particularly to a system and method for automatic finding of electromigration, self heating and Ipeak violations within a mask layout block in the metallic, polysilicon, contacts and VIA's interconnects of an integrated circuit device, and voltage drop/droop violations in the interconnects.

### BACKGROUND OF THE INVENTION

Nanometer designs contain millions of devices and operate at very high frequencies. The current densities (current per cross-sectional area) in the signal lines and power are consequently high and can result in either signal or power electromigration problems. The electron movement induced by the current in the metal power lines causes metal ions to migrate. That phenomenon of transport of mass in the path of a DC flow, as in the metal power lines in the design, is termed power electromigration. There are two types of electromigration. Uni-Directional, for example power and static signals and Bi-Directional, for example clocks and other switching signals. The most critical is the Uni-Directional electromigration type since the electron ‘erosion’ move constantly in one direction and can cause signal line failure. The power electromigration effect is. harmful from the point of view of design reliability, since the transport of mass can cause open circuits, or shorts, to neighboring wires.

Electromigration (EM) is actually not a function of current, but a function of current density. It is also accelerated by elevated temperature. Thus, electromigration is easily observed in Al or Cu alloy metal lines that are subjected to high current densities at high temperature over time. The higher current density around the void results in localized heating that further accelerates the growth of the void, which again increases the current density. The cycle continues until the void becomes large enough to cause the metal line to fuse open. Typically the most susceptible to electromigration phenomenon are metallic interconnections of integrated circuit. (IC) EM effects become more prominent as IC feature sizes decrease and as IC frequencies and current densities increase.

EM in IC devices occurs due to direct current flow. High direct current density in an IC device causes atoms and ions in the conductors of the device to move in the opposite direction of the direct current flow. In particular, when high direct current densities pass through thin conductors, metal ions accumulate in some regions and voids form in other regions of the conductors. The accumulation of metal ions may result in a short circuit to adjacent conductors and the voids may result in an open-circuit condition. However, if the current density can be kept below a predetermined EM threshold, EM can be rendered negligible for the life of any particular IC device. Therefore, EM due to direct current flow in IC devices is a major concern with respect to the potential for device failures and the overall reliability of the device.

IC devices may also have alternating current flow. The alternating current density in an IC device that results from alternating current flow causes atoms and ions in the conductors of the device to first move in one direction and then move in the opposite direction, back to their original positions. A plurality of conductors with alternating current flow is defined as a signal net. In contrast to conductors with direct current flow, conductors with alternating current flow do not directly cause EM problems. However, conductors with alternating current flow do use power and generate heat. Since EM is very sensitive to the temperature of the conductors, it is often necessary to limit the temperature increase of the conductors in IC devices that results from the heating due to alternating current flow. Therefore, the alternating current flow in a conductor does have an impact on EM because the heating due conductors with alternating current may increase the overall temperature of the IC device by heating up neighboring conductors with direct current flow.

With steep current waveform, the temperature rises very quickly due to self-heating and the temperature gradient due to insufficient heat transfer can cause significant mechanical stress. Also, the high temperature accelerates EM process in exponential way. Ipeak checks refer to the waveform analysis, where the total energy generated by electrical current in a given time interval is evaluated.

As noted above, EM effects also become more prominent as IC feature size decreases. To counteract this effect, background art methods for controlling EM used wider conductor widths for an entire IC wiring network affected by EM. However, since EM problems become less severe as one moves away from a current source pin and toward each of the current sink pins of a wiring network, wider conductor widths are typically not required for the entire IC wiring network. Often, only a small segment of the IC wiring network needs the wider conductor width to eliminate EM problems for the entire IC wiring network. Therefore, these background art methods that use wider conductors throughout the IC wiring network often wastes valuable space on the IC device.

Other background art methods provide EM control by setting limits on the power dissipated in conductors with alternating current flow. In these background art methods adjacent conductors with direct current flow are only allowed to be heated by a maximum temperature difference .DELTA.T.sub.MAX in order to maintain the reliability of the IC device. In particular, to limit the heat generated as a result of the temperature difference .DELTA.T caused by alternating current flow in adjacent conductors, a maximum root-mean-square (RMS) current limit (I.sub.RMS) is set for all conductors with alternating current flow adjacent to a conductor with direct current flow. The maximum current limit is set by: (1) considering the minimum distance between conductors with alternating current flow and conductors with direct current flow; and (2) the maximum temperature difference .DELTA.T.sub.MAX that maintains the reliability of the IC device. However, using this type of worst-case “minimum distance-between-conductors” approach to determine space between conductors also wastes valuable space on the IC device.

Electromigration failures take time to develop, and are therefore very difficult to detect until it happens. Therefore, it is imperative to eliminate electromigration and self heating issues in order to maintain a reliable integrated circuit operation for many years. The methods that require the knowledge of the currents in metal lines need the design be complete and LVS clean. Parasitic extraction then provides for back-annotation of the currents on the layout polygons and/or estimation of the currents from the parasitic capacitors and resistors. Thus produced current values are inherently very inaccurate for most of signals in the design due to lack of complete information about signal activity during the whole lifetime of a product. Currents are compared to the rules defined for the given technology, voltage, temperature and lifetime and product specifications. The violations found can be fixed by modifying the mask layout, which would require at least one more iteration to clean design from DRC, LVS and DFM errors, parasitic extraction and simulation or estimation to back-annotate currents to the polygons.

Voltage drop and droop are voltage changes from the nominal power and ground voltages due to resistance of the path from the voltage source to circuit elements. Unlike EM, the voltage drop/droop violations may cause design malfunctioning immediately, and thus in a sense are not a reliability issue. However increasing design robustness against voltage drop/droop helps its immunity from EM problems and vice versa, since lowering resistance generally means lower current densities and lower temperatures.

Analysis and/or simulation of power grid provide necessary data to improve power grid robustness. The design needs to be complete, and the process of fixing the violations is iterative. After design fix, the design may need to be cleaned from DRC, LVS and DFM violations and simulated/analyzed again.

The system and method described in this invention increase effectiveness of fixing EM, SH, Ipeak and voltage drop/droop violations. By eliminating possible violations at the early stages of the design process, the first version of the design can be completed with no penalty in time, and with less number of violations, especially gross violations, which are difficult to fix. The system is automatically adjusting metal lines, contacts and VIA'a, maintaining the process design rules correctness. In this way a significant amount of time is saved during the final reliability verification of the integrated circuit, achieving on-time tape outs and avoiding re-spins.

### SUMMARY OF THE INVENTION

In accordance with the present invention, the disadvantages and problems associated with eliminating electromigration, self heat, Ipeak and voltage drop/droop violations of a mask layout block have been substantially reduced or eliminated. In a particular embodiment, a method for eliminating EM, SH, Ipeak and voltage drop/droop violations of a mask layout block includes finding and automatic correction of electromigration and self heat rule violations within mask layout block at the early stages of the design, maintaining the process design rules (DRC Clean) and layout connectivity (LVS Clean) correctness.

In accordance with one embodiment of the present invention, an automated method for finding electromigration, self heat and I peak violations includes analyzing a selected polygon(s) in a mask layout block in GDSII format or any industry standard layout editor's database. The method includes reading the design simulation data or any other user provided data on average, root-mean-square and Ipeak currents and back-annotate it to the polygon(s). In case some or all data are not available, the method includes reading the circuit elements parameters and/or performs comparative analysis to estimate the currents. The currents can be estimated from comparing the driver strengths of the signal nets when some of them have the simulation data. The currents can be estimated in relative terms when no simulation data available.

In accordance with another embodiment of the present invention, the automatic method of finding voltage drop/droop violations includes analyzing a selected path(s) in a mask layout block in GDSII format or any industry standard layout editor's database. The resistances of different paths in power grid between power supplies and devices/blocks are evaluated and compared. The method includes reading the circuit elements parameters and calculating the voltage/droop on device/block power ports.

In accordance with another embodiment of the present invention, an automated method for eliminating electromigration, self heat, Ipeak and voltage drop/droop violations of a mask layout block includes analyzing a selected polygon(s) and path(s) in a mask layout block in GDSII format or any industry standard layout editor's database and obtaining one or more electromigration, self heat, Ipeak and voltage drop/droop rules associated with the polygon from a technology or external constraints file. The method provides a violation marker associated with the selected position for the polygon that graphically represents a space, width or length in the mask layout block where the selected polygon's or path's position complies with the electromigration, self heat, Ipeak and voltage drop/droop rules.

In accordance with another embodiment of the present invention, an automated method for eliminating electromigration, self heat and Ipeak violations of a mask layout block includes analyzing a selected polygon in a mask layout block and identifying a electromigration, self heat and Ipeak violation in the mask layout block if the selected position, with or length of the polygon is less than electromigration, self heat and Ipeak value permitted from a technology or external constraints file. If the electromigration and self heat violation is identified, the system automatically corrects the violation by moving, adjusting or modifying the problematic polygon. The system works throughout entire layout block hierarchy.

In accordance with another embodiment of the present invention, an automated method for eliminating voltage drop/droop violations of a mask layout block includes analyzing a selected path in a mask layout block and identifying a voltage drop/droop violation in the mask layout block if the selected position, width or length of the polygons in the path are less than voltage drop/droop value permitted from an external constraints file. If the voltage drop/droop violation is identified, the system automatically corrects the violation by moving, adjusting or modifying the problematic path. The system works throughout entire layout block hierarchy.

In accordance with a further embodiment of the present invention, a computer system for eliminating electromigration and self heat violations of a mask layout block includes a processing resource coupled to a computer readable memory. Processing instructions are encoded in the computer readable memory. When the processing instructions are executed by the processing resource, the instructions analyze a selected polygon or a path in a mask layout block and identify an electromigration, self heat, Ipeak and voltage drop/droop violation in the mask layout block if the selected position is less than an electromigration, self heat, Ipeak and voltage drop/droop rule from a technology or external constraints file. If the electromigration, self heat, Ipeak or voltage drop/droop violation is identified, the instructions automatically correct it via adjusting, moving or modifying the analyzed polygon.

Important technical advantages of certain embodiments of the present invention include RV Estimate & Auto Correct tool. The Estimation part of the tool performs comparative analysis and estimation of electrical currents and voltages in an integrated circuit design which can be performed when mask layout is not complete, and while mask layout is being created. The quick and efficient algorithms allow for real-time analysis of a selected polygon or a path in a mask layout block and early identification and fix of an electromigration, self heat, Ipeak and voltage drop/droop violation in the mask layout block that significantly reduces the design time for an integrated circuit. In a typical integrated circuit design process, an electromigration, self heat, Ipeak and voltage drop check tool analyzes a completed mask layout file for EM, SH, Ipeak and voltage drop/droop violations and identifies any violations in an output file. A layout designer may use the output file to manually eliminate the identified EM, SH, Ipeak and voltage drop/droop violations. Then the same IC layout block needs to be re-checked for EM, SH again and also other checks like DRC (Design Rule Check) and LVS (Layout vs. Schematics) to make sure that the connectivity and geometrical sizes are still correct with respect to technology file and schematics. These repeated cycles are time consuming and tedious procedures that can be eliminated using the presented invention. The time needed to complete the entire design process for the integrated circuit, therefore, may be substantially reduced since it may eliminate some steps or cycles of checking the layout with an EMSH/voltage drop tool and correcting the identified electromigration and self heat violations.

Auto Correction part of the tool further reduces the design time for an integrated circuit by automatically correcting electromigration, self heat, Ipeak and voltage drop/droop violations of a mask layout block while maintaining its correctness with respect to the process design rules and circuit connectivity. A layout designer may execute an IC layout block with electromigration, self heat, Ipeak and voltage drop/droop violations and the RV Estimate & Auto Correct tool highlights a violation marker that may represent a position, width, space or length in the layout block and eliminates the electromigration, self heat, Ipeak and voltage drop/droop violation according to technology or external constraints file. In addition the RV Estimate & Auto Correct tool provides an information window with the current and fixed electromigration, self heat and Ipeak conditions related to the selected polygon and voltage drop/droop conditions related to the selected path. The correction action may change the selected polygon/path width, length or space according to electromigration and self heat rules taken from technology or external constraints file while maintaining the process design rule (DRC Clean) and layout connectivity (LVS Clean) correctness. The system will automatically adjust the amount of contacts or vias according to electromigration and self heat rules taken from technology or external constraints file. The mask layout block, therefore, may be free of electromigration, self heat, Ipeak and voltage drop/droop violations.

All, some, or none of these technical advantages may be present in various embodiments of the present invention. Other technical advantages will be readily apparent to one skilled in the art from the following figures, descriptions, and claims.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates currents in the signal net near the output of the multi-leg transistor. The EM, SH and Ipeak checks need to be performed at six points, which also relate to metal segments or vias/via arrays extracted by a typical parasitic extraction. The points are enumerated from 1 to 6. When no data available on the currents, a comparative analysis can estimate relative ratios of electrical current densities (average, RMS and peak) to the maximum permitted ones by the rules for metal1,2,3 and vi 1,2. This can be done by in the following way: assuming the currents in both transistor legs be equal, the current at point #1 divided by maximum current at this point (derived from metal1 rule and metal1 width), is used as a reference ratio and the ratios at points 2-6 are estimated relative to the ratio at point #1. For example, assuming rules for metal1,2,3 rules are the same, the ratio at point #2 is equal 2, the ratio at point #4 is larger than 2 because of smaller width. The weakest spot could be at point #6 since it is the narrowest metal, or at #3, 5 depending on via rules. Based on the threshold, the weakest spots elements may need to be fixed, e.g. metal3 need to be widened.

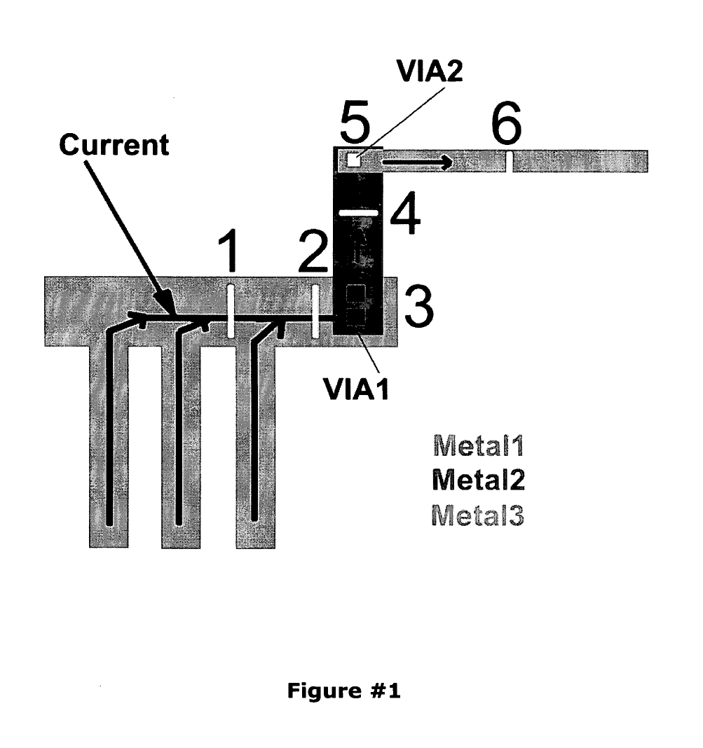

FIG. 2 illustrates seven Metals, each analyzed for electromigration and/or self heat conditions, defined by the process technology and/or external constraints file. All Metal2 lines WIDTH was found smaller then required for electromigration and self heat rules. Metal3 line LENGTH was found shorter then required by electromigration and self heat rules. The information violation markers represent an electromigration and self heat violations on the polygons that they are attached into.

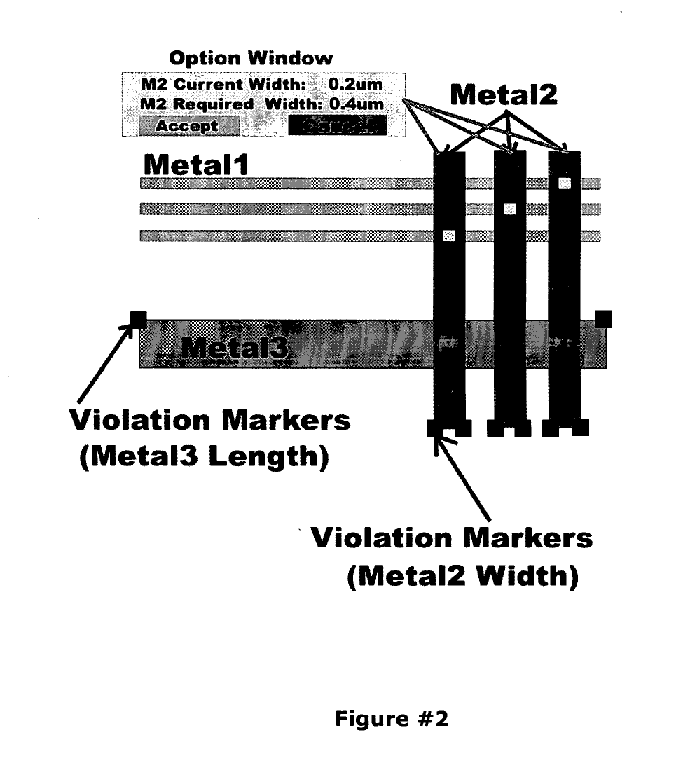

Metal 2 wires have WIDTH violation shown by violation markers.

Metal 3 wire has LENGTH violation shown by violation markers.

FIG. 3 illustrates the Metal2 and Metal3 lines after the RV Estimation & Auto Correct tool correction action. The Metal2 lines are WIDER and include more VIA1''s. The Metal3 line is LONGER and includes more VIA2. When hovering above the INFORMATION marker, option windows will appear with the option to ACCEPT the correction or to CANCEL it. User may choose to accept or cancel some of the corrections only.

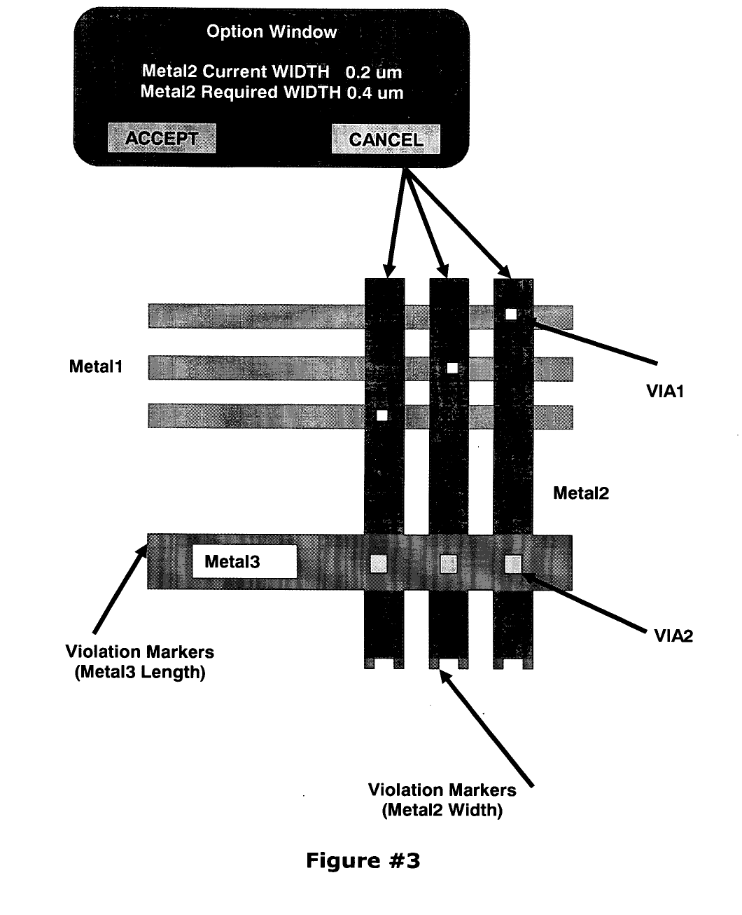

FIG. 4 Illustrates comparative analysis of voltage drop/droop in a power grid. Different metals are shown by different colors. The top layers (blue, purple) form a regular grid. The lower metal layers (green, brown, light blue, dark green, red) form a tree-type structure and two branches steaming out off the regular part of the grid have different resistances. The left branch contains longer and narrower metal segments, and thus its resistance is higher. With the currents and/or circuit elements data available the static voltage drop/droop in each branch can be estimated by Ohm's. law dV=I*R. When current data are not available, the tool assumes the current be proportional to the size of the devices driven. When no circuit data available it assumes the same current in both branches, and compares just their total resistances. If the left branch resistance is higher by more than the threshold defined in the constraints file, the violation to be reported for the left branch.

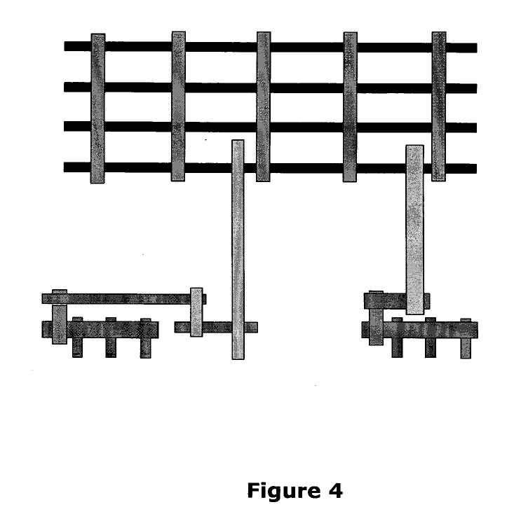

FIG. 5 illustrates a flow chart for one example of a method for evaluation of currents and voltages and automatic elimination of electromigration, self heat, Ipeak and/or voltage drop/droop violations of a mask layout block in accordance with teachings of the present invention.

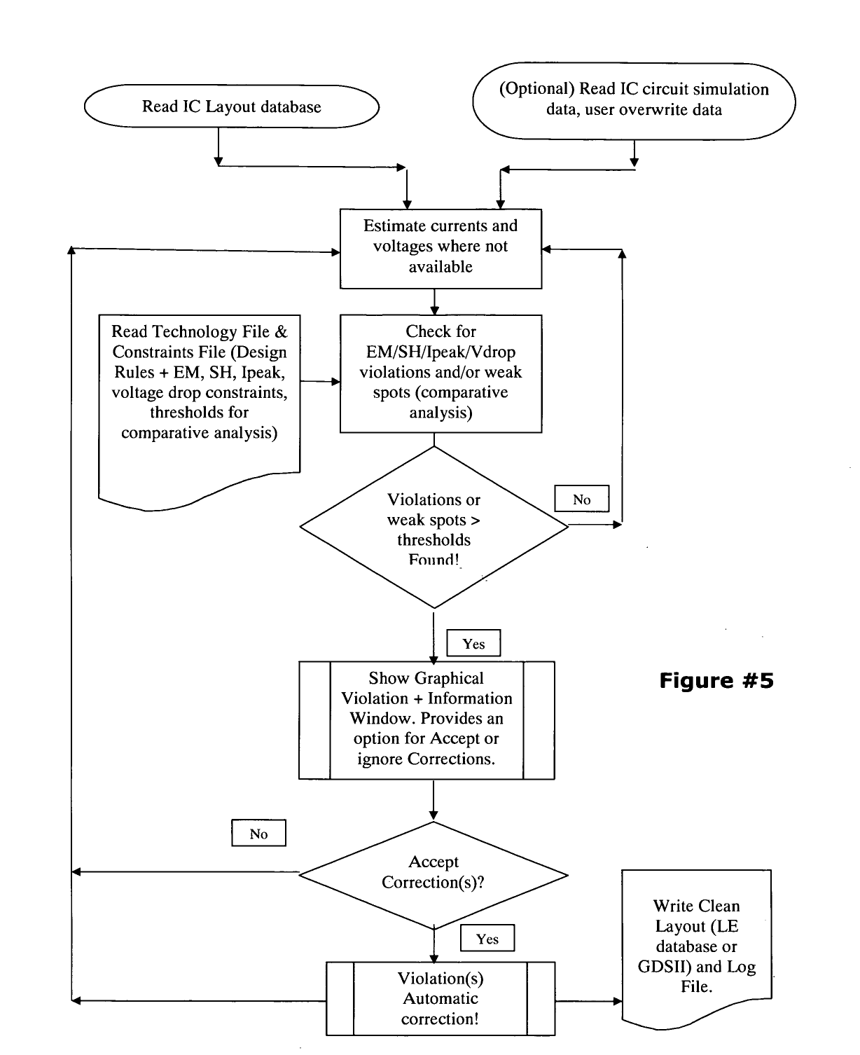

### DETAILED DESCRIPTION OF THE INVENTION

The processing instructions may include a commercially available layout editor interfaced with RV Estimate & Auto Correct tool or independent IC layouts block in GDSII format. The RV Estimate & Auto Correct tool may provide the ability to analyze the width, length and placement of polygons in a mask layout block, complete or not, and determine if an electromigration, self heat, Ipeak and voltage drop/droop violation was created. The RV Estimate Auto Correct tool may automatically correct all electromigration, self heat, Ipeak and voltage drop/droop violation maintaining process design rules (DRC Clean) and layout connectivity (LVS) correctness.

When a layout designer creates a mask layout block it may contain electromigration, self heat, Ipeak and voltage drop/droop violations or polygons/paths where violations are likely after the block will be completed. The RV Estimate & Auto Correct tool reads the layout block information from GDSII format file or from industry standard layout editor's database system. In addition the RV Estimate & Auto Correct tool reads a technology and/or external constraints file corresponding to a desired manufacturing process. The technology file may contain design rules for the desired manufacturing process that ensures an integrated circuit fabricated on a semiconductor wafer functions correctly. In addition the technology file may contain electromigration, self heat and Ipeak rules to ensure reliable integrated circuit operation for desired time period.

Furthermore, the tool has an option to read a constraints file which may contain design specific electromigration, self heat and Ipeak rules to ensure reliable integrated circuit operation for desired time period, and voltage drop/droop rules based on the design specifications and the technology. Within the mask layout block, the electromigration, self heat and Ipeak rules may define the minimum or maximum allowable feature dimensions (e.g., metal and polysilicon wires width, spaces and length) for the desired manufacturing process. In addition the electromigration, self heat and Ipeak rules may define the correct number of contacts and VIA's in order to maintain accurate electrical current flow without causing metal lines failures.

Furthermore, the tool has an option to read a file which contains layout extraction information (resistance and capacitance values) and/or simulation or user specified currents data per circuit net. The RV Estimate & Auto Correct tool then uses design and/or the parasitics/currents data and EM, SH, Ipeak and voltage drop/droop rules to estimate the ratios of currents and voltage drops/droops to the maximum permitted values derived from the rules: I/Irule, dV/dVrule. When the currents and/or voltage data are available, the tool works in regular mode and calculates the absolute ratios. When the currents and/or voltage data are not available for some or all parts of the design, the tool switches to comparative mode and calculates the relative ratios. The relative ratios for EM, SH and Ipeak are calculated by dividing the ratios by the ratio for some polygon within the same signal net. The relative ratios for voltage drop/droop are calculated by dividing the ratios by the ratio at some point in the same part of power grid. The relative ratios can be calculated at early stages of design process, when design is not complete, and no simulation or any other data available. The comparative analysis of the relative ratios can quickly identify the weakest spots (polygons, paths) with the largest relative ratios in the mask layout block, and report them as violations based on the threshold specified in the constraints file. The accuracy of the comparative mode is inferior but comparable to the accuracy of the regular mode, since the last is usually very inaccurate due to lack of the accurate switching activity and other information.

The RV Estimate & Auto Correct tool displays graphically violations through a violation marker layer that is provided with industry standard layout editors. The RV Estimate & Auto Correct tool may graphically represent the violation marker in the mask layout block by highlighting the required width, length or space with an appropriate color and/or pattern. The violation marker color and/or pattern can be set in an initial tool setup. In addition the RV Estimate & Auto Correct tool may show an Information Window with the current and fixed results. The Information Window also provides with the option to accept the correct new layout or ignore the correction results.

After the RV Estimate & Auto Correct tool completed its automatic electromigration, self heat, Ipeak and voltage drop/droop correction, user may have the option to accept the corrected layout or to ignore it and return to the original layout cell. The RV Estimate & Auto Correct tool may guide the layout designer about EM, SH, Ipeak and voltage drop/droop violations within the mask layout block using violation marker. If the layout designer chooses to comply with the electromigration, self heat, Ipeak and/or voltage drop/droop corrections, the RV Estimate & Auto Correct tool automatically creates new layout cell that includes all corrections and maintains the process design rules (DRC Clean) and layout connectivity (LVS Clean) correctness.

The RV Estimate & Auto Correct operates in flat mode and hierarchical mode. When layout designer chooses to work in hierarchical mode, the RV Estimate & Auto Correct tool will work throughout the entire hierarchy correcting all electromigration, self heat, Ipeak and voltage drop/droop violations. In Flat Mode the RV Estimate & Auto Correct tool will fix all electromigration and self heat violations in the current cell level only.

The RV Estimate & Auto Correct tool is included an entire layout block Check mode. This mode is aimed to be activation with the completion of the entire layout block. Using this feature the entire block will be analyzed for electromigration, self heat, Ipeak and voltage drop/droop violations. When analysis is complete all violations will be shown using violation marker. This mode operates in flat or fully hierarchical mode.

The processing instructions for automatic correction of electromigration, self heat, Ipeak and/or voltage drop/droop violations in a mask layout file may be encoded in computer-usable media. Such computer-usable media may include, without limitation, storage media such as floppy disks, hard disks, CD-ROMS, DVDs, read-only memory, and random access memory; as well as communications media such as wires, optical fibers, microwaves, radio waves, and other electromagnetic or optical carriers.

1. An automated method for finding electromigration, self heat, Ipeak and voltage drop/droop violations of a an integrated circuit, comprising: reading integrated circuit layout database, complete or not, in GDSII format or industry standards layout editor's database; reading integrated circuit elements parameters in Spice format or industry standard format; reading circuit simulation results in the proprietary format; estimating the currents and voltages when not provided by simulation data; analyzing a selected polygon in the mask layout block; analyzing other polygons in vicinity of the polygon; obtaining one or more electromigration, self heat, Ipeak rules associated with the polygon from a technology and/or external constraints file in the proprietary format; obtaining voltage drop/droop rules from external constrains file; providing an information window with the current and required integrated circuit electromigration and/or self heat parameters; providing a violation marker associated with the selected position for the polygon, the violation marker operable to graphically represent a width, space, length or any other polygon's characteristic (Polygon's Metal type) in the mask layout block where the selected polygon complies with the electromigration, self heat, Ipeak and voltage drop/droop rules.

2. The method of claim 1, further comprising: analyzing the mask layout block for existence of electromigration and/or self heat violations which are determined by a technology file and/or external constraints ASCII file which contains net's capacitance, resistance parameters and other integrated circuit relate reliability factors.

3. The method of claim 1, further comprising: estimating the average, root mean square and Ipeak currents from circuit element parameters and the circuit simulation data available for other parts of the design.

4. The method of claim 1, further comprising: determined if a selected area, through a selection box, contains sufficient amount of CONTACT or VIA polygons in order to comply with electromigration and/or self heat rule, taken from a technology and/or external constraints file.

5. The method of claim 1, further comprising the electromigration and/or self heat rules selected from a group consisting of a metals spacing, polysilicon spacing, contact spacing and all types of VIA spacing.

6. The method of claim 1, further comprising the electromigration and/or self heat rules selected from a group consisting of a metals length, polysilicon length, contact length and all types of VIA length.

7. The method of claim 1, further comprising the electromigration and/or self heat rules selected from a group consisting of a metals width, polysilicon width, contact width and all types of VIA width.

8. The method of claim 1, wherein the selected position for the polygon comprises a location for the polygon in the mask layout block.

9. The method of claim 1, wherein the selected position for the polygon comprises a location for edges of the polygon in the mask layout block.

10. The method of claim 1, wherein the mask layout block is hierarchical.

11. An automated method for analyzing the whole signal path, complete or not, the polygon belongs to; if the path is a part of power grid, perform comparative analysis of the path and other power grid paths; evaluate the path resistance differences and the associated voltage drop/droop differences; perform comparative analysis of the polygons in the path; evaluate and compare the polygons robustness against EM, SH and Ipeak.

12. The method of claim 11, further comprising reporting the power grid paths that have a higher voltage drop/droop than other paths by a threshold defined in the constraints file.

13. The method of claim 11, further comprising automatically re-routing selected paths while maintaining process design rules (DRC Clean) and layout connectivity (LVS Clean) correctness.

14. The method of claim 11, further comprising calculating the maximum currents allowed by EM, SH and Ipeak rules for each polygon in the path taken from a technology and/or external constraints file.

15. The method of claim 11, further comprising estimating the currents in the branches of the path.

16. The method of claim 11, further comprising reporting the polygons with the maximum currents permitted lower than in other polygons in the same branch by a threshold defined in the constraints file.

17. The method of claim 11, further comprising automatically adjusting the width of the selected polygon until the electromigration, self heat and/or Ipeak violation is eliminated.

18. The method of claim 11, further comprising automatically adjusting the length of the selected polygon until the electromigration, self heat and/or Ipeak violation is eliminated.

19. The method of claim 11, further comprising automatically adjusting the amount of the selected contacts or VIAs until the electromigration and/or self heat violation is eliminated.

20. The method of claim 11, wherein the mask layout block is hierarchical.

21. A computer system for eliminating electromigration and/or self heat violations of a mask layout block, comprising: a processing resource; a computer readable memory; and processing instructions encoded in the computer readable memory, the processing instructions, when executed by the processing resource, operable to perform operations comprising: reading GDSII layout block or industry standard layout editor's database and; analyzing a selected polygon in the mask layout block; providing a violation marker associated with the polygon; providing an information window with the current and required integrated circuit electromigration and/or self heat parameters; determining if the selected position, width or length of the selected polygon produces a electromigration, self heat and/or Ipeak violation in the mask layout block based on an electromigration and/or self heat rule taken from a technology and/or external constraints file; and automatically correcting the electromigration, self heat and/or Ipeak violation if exists, maintaining process design rules (DRC Clean) and layout connectivity (LVS Clean) correctness.

22. The system of claim 21, further comprising the instructions operable to perform operations including automatically placing the polygon in an original position in the mask layout block if the electromigration, self heat and/or Ipeak violation exists.

23. The system of claim 21, further comprising the instructions operable to perform operations including automatically adjusting the selected position until the electromigration, self heat and/or Ipeak violation is eliminated.

24. The system of claim 23, further comprising the instructions operable to perform operations including automatically adjusting the width and/or length of the selected polygon until the electromigration, self heat and/or Ipeak violation is eliminated.

25. The system of claim 21, further comprising the instructions operable to perform operations including automatically adjusting part of the polygon's width and/or length until the electromigration, self heat and/or Ipeak violation is eliminated.

26. The system of claim 21, further comprising the instructions operable to perform operations including: determining if the selected position for the polygon creates an electromigration and/or self heat violation in the mask layout block according to electromigration and/or self heat rule taken from a technology and/or external constraints file; and modifying the selected polygon position, width or length until the electromigration and/or self heat is approximately equal to the associated technology file rule and/or complying with external constraints file rule according to priority.

27. Software for eliminating electromigration and/or self heat violations of a mask layout block, the software being embodied in computer-readable media and when executed operable to: read integrated circuit database file in GDSII format and; analyze a selected polygon in the mask layout block; providing a violation marker associated with the polygon; providing an information window with the current and required integrated circuit electromigration and/or self heat parameters; and determining if the selected position, width or length of the selected polygon produces an electromigration, self heat and/or Ipeak violation in the mask layout block based on an electromigration, self heat and/or Ipeak rule from a technology and/or external constraints file; and automatically correct the electromigration and/or self heat violation if exists, maintaining the process design rules (DRC Clean) and layout connectivity (LVS Clean) correctness.

28. The software of claim 27, further operable to automatically place the polygon in an original position in the mask layout block if the electromigration, self heat and/or Ipeak violation exists.

29. The software of claim 27, further operable to automatically adjust the selected polygon's position and width and length until the electromigration, self heat and/or Ipeak violation is eliminated.

30. The software of claim 27, further operable to automatically adjust the selected polygon's position and partial width and length until the electromigration, self heat and/or Ipeak violation is eliminated.

31. The software of claim 27, further operable to automatically adjust selected VIA's position and/or amount until the electromigration, self heat and/or Ipeak violation is eliminated.

32. The software of claim 27, further operable to automatically adjust selected CONTACTS position and/or amount until the electromigration and/or self heat violation is eliminated.

33. The software of claim 27, wherein the mask layout block is hierarchical.
